(19) United States
(12) Patent Application Publication
(10) Pub. No.: US 2006/0165410 A1
(43) Pub. Date: Jul. 27, 2006

(54) Arrangement for avoiding node isolation in all-optical communication networks

(75) Inventors: Martin Birk, Belford, NJ (US); Angela Lan Chiu, Holmdel, NJ (US); Dah-Min D. Hwang, Holmdel, NJ (US); John L. Strand, Holmdel, NJ (US); Kathleen A. Tse, Holmdel, NJ (US)

Correspondence Address: AT&T CORP., ROOM 2A207, ONE AT&T WAY, BEDMINSTER, NJ, 07921, US

(73) Assignee: AT&T Corp.

(21) Appl. No.: 11/043,582

(22) Filed: Jan. 26, 2005

(51) Int. Cl. G02F 1/00

(52) U.S. Cl. 398/4

(57) ABSTRACT

An arrangement in a node in an optical communication network has one or more terminals 220 and/or 222 configured to provide local access to the network through the node, and an all-optical routing arrangement 202-204-206-208 configured to route optical signals among optical pathways extending from the node. The optical pathways include inter-node optical pathways (for example, pathways N and/or W) configured to carry optical signals into and out of the node to respective other elements in the network, as well as intra-node optical pathways (for example, pathway E) dedicated to carry optical signals between the routing arrangement and respective terminals so as to provide the local access to the network through the node. Placing the terminals on optical pathways allows redundancy of the terminals to avoid node isolation if a terminal fails, yet is more economical than conventional arrangements requiring a terminal for each pathway into the node.

### BACKGROUND OF THE INVENTION

1. Field of the Invention

The invention relates to arrangements for avoiding node isolation, especially in all-optical networks. More specifically, the invention relates to arrangements for economically avoiding node isolation by dedicating one or more of the optical pathways extending between respective terminals and the node's optical switching arrangement, thus avoiding the need to provide a terminal for each and every optical pathway leading from the node.

2. Related Art

The problem of node isolation has long been known in distributed communication networks. Briefly, for purposes of this disclosure, node isolation may be defined as a condition in which the node is not able to communicate with any other node in a network. Node isolation may be caused by cutting of optical fiber cables, although a cause of node isolation that is particularly pertinent to the present invention involves failure of a terminal within a node itself. In any event, node isolation can prevent optical mesh restoration, which for purposes of this disclosure may be defined as restoring optical signals in a mesh environment after a failure, using all-optical means only.

FIG. 1 illustrates a conventional wavelength selective switch (WSS) 100 configured to route optical signals between and among three bidirectional optical pathways W, N, and E. (Of course, W, N, and E are arbitrary designation of the pathways, and the pathways are not required to extend in respective westward, northward, or eastward directions.)

The FIG. 1 architecture reflects an approach to optical adding and dropping called “broadcast and select,” in which each direction of transmission has a dedicated add drop terminal (ADT). In FIG. 1, frequencies incoming on optical pathway W from an optical amplifier A and passive coupler (or splitter) 1 are sent to N×1 switches 114 and 116 for the N and E pathways, respectively; coupler 1 also drives a first local add drop terminal (ADT) 102. Likewise, frequencies incoming on optical pathway N from an optical amplifier C and passive coupler (or splitter) 3 are sent to N×1 switches 112 and 116 for the W and E pathways, respectively; coupler 3 also drives a second local ADT 104. Similarly, frequencies incoming on optical pathway E from an optical amplifier e and passive coupler (or splitter) 5 are sent to N×1 switches 112 and 114 for the W and N pathways, respectively; coupler 5 also drives a third local ADT 106.

For output from the WSS, frequencies from local ADT 102 are coupled with the output of N×1 switch 112 into output pathway W by coupler 2, which drives optical amplifier B. Likewise, frequencies from local ADT 104 are coupled with the output of N×1 switch 114 into output pathway N by coupler 4, which drives optical amplifier D. Similarly, frequencies from local ADT 106 are coupled with the output of N×1 switch 116 into output pathway E by coupler 6, which drives optical amplifier F.

Local ADTs 102, 104, 106 communicate separately with a switch 120 (which is optional, and may be a matrix switch), which in turn is controlled by a router 130. Router 130 communicates with upper layer elements (not specifically illustrated), and provides network layer control and data signals to the lower level (data link layer) switch 120.

Significantly, the FIG. 1 arrangement requires one local add-drop terminal (ADT) for each pathway. Thus, a node of degree n requires n separate ADTs, a costly requirement especially for higher-degree nodes. Although the dedication of an ADT to each pathway (fiber pair) allows straightforward wavelength planning, because every signal has to be able to go out in every direction, this architecture does not lend itself to optical mesh restoration unless switch 120 is added. However, adding switch element 120 makes this architecture even more costly.

Conventionally, issues involved in optical mesh restoration have not been adequately considered by artisans involved in physical layer implementations. Conversely, issues involved in physical layer implementations of switching nodes have been given inadequate consideration by artisans involved in optical mesh restoration. Thus, optical network technology has lacked an integrated approach that would provide an arrangement that avoids node isolation while permitting mesh restoration.

The problem of node isolation has long been recognized in network engineering. Various artisans (for example, U.S. Patent Application Publication No. 2003/0202534 to Cloonan) have adopted the conventional approach of purposely isolating a faulty node. Others have adopted schemes for self-healing networks (see U.S. Patent Application Publication No. 2002-0064166 to Suetsugu et al.). Various others have recognized that node isolation can occur for a variety of reasons, including fiber cuts (see U.S. Pat. No. 5,406,401 and U.S. Pat. No. 6,807,190, both to Kremer), and have developed ways of recovering from failures with various schemes such as selective span switching. Still others have adopted approaches in which knowledge about a network's nodes connection state may be distributed throughout the other nodes (see U.S. Pat. No. 6,751,189 to Gullicksen et al.).

However, none of the conventional arrangements appear to have solved the problems described above, relating to node isolation and its implications concerning mesh restoration. Thus, there is a need in the art for an arrangement that avoids node isolation in the first place, and further, permits mesh restoration in optical networks, especially an arrangement that does not increase in cost in direct proportion to the degree of the node.

### SUMMARY

The invention provides an arrangement at a node of an optical communication network. The arrangement involves t terminals configured to provide local access to the network through the node (wherein t≧1), an all-optical routing arrangement configured to route optical signals among n optical pathways extending from the node (wherein n>t), and the n optical pathways configured to carry optical signals. The n optical pathways include n−t inter-node optical pathways configured to carry optical signals into and out of the node to respective other elements in the optical communication network, and t intra-node optical pathways dedicated to carry optical signals between the routing arrangement and respective terminals so as to provide the local access to the network through the node.

### BRIEF DESCRIPTION OF THE DRAWINGS

A more complete appreciation of the described embodiments is better understood by reference to the following Detailed Description considered in connection with the accompanying drawings, in which like reference numerals refer to identical or corresponding parts throughout, and in which:

FIG. 1 is a schematic block diagram showing a conventional wavelength selective switch (WSS) in which one local add-drop terminal (ADT) is required for each pathway;

FIG. 2A is a schematic block diagram of one embodiment of an arrangement in which a single terminal is employed regardless of the number of pathways entering the node;

FIG. 2B is a schematic block diagram of an embodiment of an arrangement for avoiding node isolation in optical networks, in which plural terminals are employed; and

FIG. 3 is a flowchart illustrating one embodiment of a method of performing optical mesh restoration in a network including the node described herein.

### DETAILED DESCRIPTION

In describing embodiments illustrated in the drawings, specific terminology is employed for the sake of clarity. However, the invention is not intended to be limited to the specific terminology so selected, and it is to be understood that each specific element includes all technical equivalents that operate in a similar manner to accomplish a similar purpose. Various terms that are used in this specification are to be given their broadest reasonable interpretation when used to interpret the claims.

Moreover, features and procedures whose implementations are well known to those skilled in the art are omitted for brevity. For example, the selection, construction and/or use of elements employed in optical communications (such as repeaters, couplers, switches, wavelength blocking elements, terminals, and the like) are readily accomplished by those skilled in the art, and thus their details may be omitted. Also, common network communications techniques and network management techniques may be only briefly mentioned or illustrated, their details being well known by skilled artisans. Thus, the steps involved in methods described herein may be readily implemented by those skilled in the art without undue experimentation.

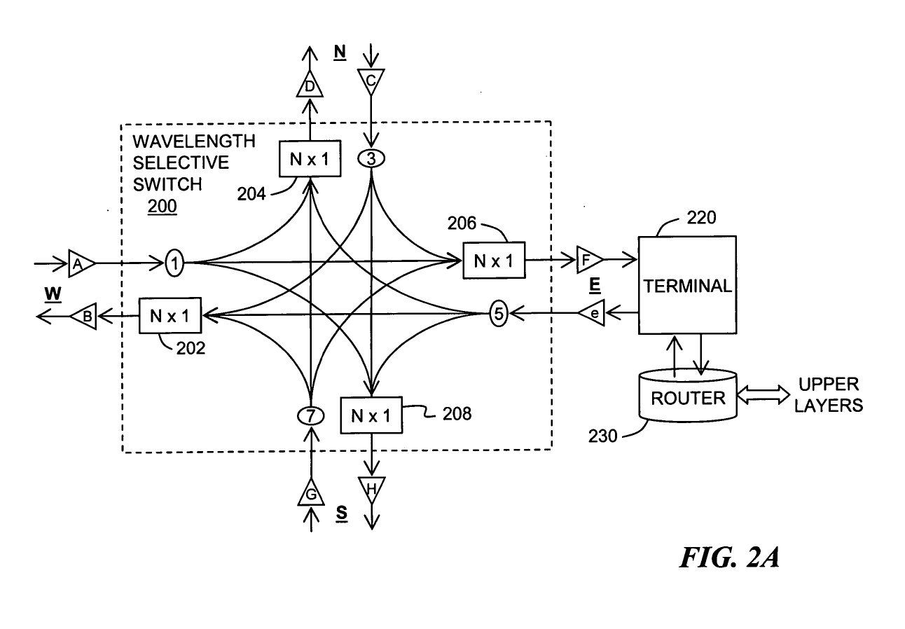

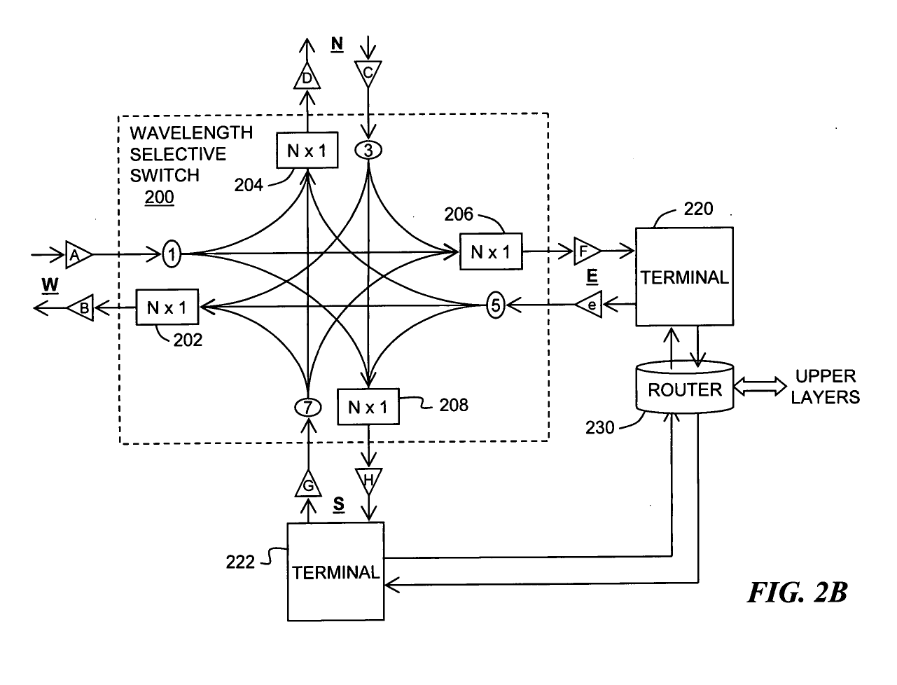

FIG. 2A is a schematic block diagram of one embodiment of an implementation of a node in optical networks, in which a single terminal is employed regardless of the number of pathways entering the node. Referring to FIG. 2A, a wavelength selective switch (WSS) 200 is shown that has three optical pathways N, W and S. (Of course, N, W and S are arbitrary designation of the pathways, and the pathways are not required to extend in respective westward, northward, or eastward directions.) A fourth optical pathway, arbitrarily chosen and designated E, is specially dedicated for local management of the WSS.

Frequencies incoming on optical pathway W from an optical amplifier A and passive coupler 1 are sent to N×1 switches 204, 206, 208 for the N, E, and S pathways, respectively. Likewise, frequencies incoming on optical pathway N from an optical amplifier C and passive coupler 3 are sent to N×1 switches 202, 206, 208 for the W, E, and S pathways, respectively. Similarly, frequencies incoming on optical pathway S from an optical amplifier G and passive coupler 7 are sent to N×1 switches 202, 204, 206 for the W, N and E pathways, respectively. Switches 202, 204, 206, 208 may be implemented as boxes with N+1 fibers, that split the wavelengths inside and operate on a per-wavelength basis to switch each individual wavelength from one of the N ports to the one other port.

Switch 206 drives a terminal 220 on pathway E via (optional) optical amplifier F. Terminal 220 drives switches 202, 204, 208 for the respective W, N and S pathways, via optional amplifier e and coupler 5. The switches 202, 204, 208 drive output pathways W, N and S via optical amplifiers B, D and H, respectively. Terminal 220 communicates with and may be governed by a router 230. Alternatively, the terminal may be centrally controlled by a network management entity. Router 130 provides network layer control and data signals to the lower level (data link layer) terminal 220, and communicates with upper layer elements (not specifically illustrated).

Terminal 220 may be implemented in a variety of ways. A “tunable” terminal implementation includes wavelength independent passive couplers with tunable filters (TF). Another implementation is a wavelength dependent “fixed” multiplexer-demultiplexer with amplification. Terminals, as such, are well known in the art. If the terminal is made with the wavelength independent passive couplers (as drawn in FIG. 2A), a tunable laser and tunable filter may be provided for maximum flexibility. Terminal 220 may include a regenerator (more generally, a transponder). Transponders generally have a “line side” facing the WDM system (here, the wavelength selective switch 200), as well as a “client side” or “tributary” facing the external equipment (here, router 230 or other service device).

Moreover, elements in FIG. 2A are merely examples of what may be employed, with the understanding that substitutes may be used as desired. For example, elements 202, 204, 206, 208 have been described as N×1 switches that choose one input out of N inputs at a time, for every wavelength; however, it is understood that such elements may be implemented, for example, as wavelength blocking elements. Likewise, router 230 is one example of a device controlled by a transport layer routing protocol, but more generally exemplifies a service device such as a SONET device.

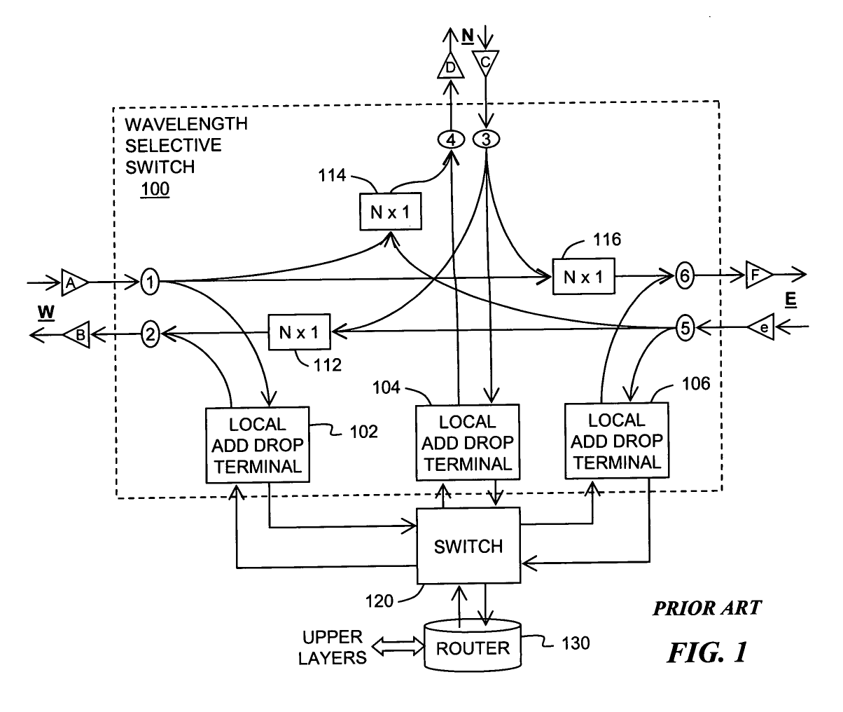

Advantageously, the FIG. 2A arrangement permits optical restoration much more cost-efficiently than the conventional arrangement of FIG. 1. Unfortunately, failure of amplification elements e or F, for example, keeps router 230 from sending traffic into the network, thereby isolating the node. Despite its problems, the FIG. 2A arrangement is significantly more economical than that of FIG. 1 because FIG. 2A has only a single terminal 220 compared to FIG. 1's three ADTs 102, 104, 106 plus switch 120.

The manner in which the FIG. 2A arrangement enables optical mesh restoration is based on the way terminal 220 is connected to WSS 200, and the way it operates. In particular, the inventive arrangement in FIG. 2A includes a terminal 220 that receives its inputs and provides its outputs at points that are “outside” the WSS 200 itself. This connection is in contrast to the arrangement in FIG. 1, which involves plural local ADTs that receive their inputs and provides their outputs “inside” the WSS. By replacing the internal connections of the conventional FIG. 1 WSS with the single external connection in FIG. 2A, the arrangement in FIG. 2A not only reduces hardware costs, but supports expandability and redundancy, as will be described in greater detail with reference to FIG. 2B

FIG. 2B is a schematic block diagram of an embodiment of an arrangement for avoiding node isolation in optical networks, in which plural terminals (exemplified by elements 220, 222) are employed on corresponding pathways arbitrarily chosen and designated E and S. Of course, the illustrated use of pathways E and S to connect to terminals 220, 222 is arbitrary; the terminals could have been connected to any of the pathways so as to leave the remaining pathways free for use to communicate with other network elements. The structure and operation of like-numbered elements in FIG. 2B corresponds to those in FIG. 2A, and accordingly description thereof is not repeated.

The arrangement of FIG. 2B differs from that of FIG. 2A by the presence of a second terminal 222 to which pathway S is dedicated. Terminal 222 is connected to the wavelength selective switch 200 on the bidirectional S pathway. Terminal 222 operates in the same way as terminal 220, and communicates with and is governed by router 230.

By providing plural terminal blocks, exemplified in FIG. 2B by elements 220, 222, a degree of redundancy is provided. The redundancy avoids the single point of failure in FIG. 2A that might cause the entire node to go down. That is, if FIG. 2A's terminal 220 fails, or if the bidirectional pathway E is severed or otherwise fails, then the entire node fails. In contrast, if the same single mode of failure afflicts the arrangement in FIG. 2B, then terminal 222 assumes the functions that terminal 220 can no longer perform. In this manner, the FIG. 2B arrangement can cope with certain single point of failure modes that FIG. 2A arrangement would not survive.

The invention provides that more than two terminals may be employed at a single node (WSS). For example, according to one design approach, nodes of degree of four or less may be equipped with two terminals, nodes of degree nine or less may be equipped with three terminals, and so forth. More generally, nodes of degree n² or less may be equipped with n terminals. This design approach causes cost to vary in proportion to n^{1/2} rather than proportional to n as in FIG. 1, and is believed to reflect a rational trade-off among considerations of isolation, wavelength blocking, and cost. Of course, this design approach is only one example of those that may embody the invention.

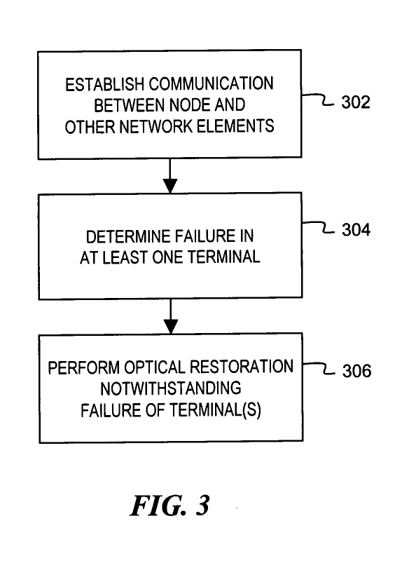

FIG. 3 is a flowchart illustrating a method of performing optical mesh restoration in a network including the node described herein.

Block 302 indicates establishing communication between the node and the first and second other network elements.

Block 304 indicates determining a failure in one of the first terminal 220 and the second terminal 222.

Block 306 indicates performing optical mesh restoration so as to continue the routing of optical signals among the first and second optical pathways N, W, notwithstanding the failure in one of the first terminal 220 and the second terminal 222.

Thus, advantageously, as long as a single terminal is still functioning at a node, the node need not be isolated and mesh restoration can proceed even in the failure of one or more terminal failures (or failures in the pathway between the switches and the terminals).

From the foregoing, it will be apparent to those skilled in the art that a variety of methods, systems, and the like, are provided.

The foregoing description provides support for an arrangement (see, for example, FIG. 2A or 2B) at a node of an optical communication network. The arrangement may involve t terminals configured to provide local access to the network through the node, wherein t≧1, an all-optical routing arrangement (20x=202-204-206-208) configured to route optical signals among n optical pathways extending from the node, wherein n>t; and the n optical pathways configured to carry optical signals. The n optical pathways may include n−t inter-node optical pathways configured to carry optical signals into and out of the node to respective other elements in the optical communication network, and t intra-node optical pathways dedicated to carry optical signals between the routing arrangement and respective terminals so as to provide the local access to the network through the node.

In the arrangement, t may equal 1, or it may be greater than 1.

When t≧2, if there are f failures in f terminals or respective intra-node optical pathways between the f terminals and the all optical routing arrangement, wherein f<t, then t−f non failing terminals are configured to continue to provide the local access to the network through the node so as to prevent node isolation.

In the arrangement, t may be a smallest integer ≧n^{1/2}

At least one of the terminals (220) may be configured to communicate with a device (230) providing network layer control to the first terminal.

At least one of the terminals (220) may be configured to communicate with a centralized network control entity.

The foregoing description also provides support for an arrangement (FIG. 2A or 2B) at a node (200+220) of an optical communication network. The arrangement may involve a first optical pathway (N) extending from the node toward a first other element in the optical communication network, and configured to carry optical signals into and out of the node; a second optical pathway (W) extending from the node toward a second other element in the optical communication network, and configured to carry optical signals into and out of the node; a third optical pathway (E, or E-and-S), extending from the node and configured to carry optical signals; an all-optical routing arrangement (20x) configured to route optical signals from any of the first, second and third optical pathways to any other optical pathway selected from among the first, second and third optical pathways; and at least a first terminal (220) connected to the routing arrangement (20x) only via the third optical pathway (E).

The first terminal (220) may be configured to communicate with a device (230) providing network layer control to the first terminal.

The first terminal (220) may be configured to communicate with a centralized network control entity.

The arrangement may further involve a fourth optical pathway (S), extending from the node and configured to carry optical signals, and a second terminal (222) connected to the routing arrangement (20x) only via the fourth optical pathway. The second terminal (222) may be configured to communicate with a device (230) providing network layer control to the second terminal. The second terminal (222) may be configured to communicate with a centralized network control entity.

A failure of the first terminal (220) may not interrupt the carrying of optical signals between the second terminal and the all-optical routing arrangement; and a failure of the second terminal (222) may not interrupt the carrying of optical signals between the first terminal and the all-optical routing arrangement.

A failure of the first terminal (220) does not interrupt the routing of optical signals between the first (N) and second (W) optical pathways.

The present disclosure further supports a method (FIG. 3) of performing optical mesh restoration in a network including the arrangement described herein, the method involving establishing communication between the node and the first and second other network elements; determining a failure in one of the first terminal (220) and the second terminal (222); and performing optical mesh restoration so as to continue the routing of optical signals among the first (N) and second (W) optical pathways notwithstanding the failure in one of the first terminal (220) and the second terminal (222).

The present disclosure further supports A method of locally accessing an optical communication network through a node having t≧1 terminals and n>t optical pathways extending from the node, the n optical pathways including (a) n−t inter-node optical pathways configured to carry optical signals into and out of the node to respective other elements in the optical communication network, and (b) t intra-node optical pathways dedicated to carry optical signals between an all-optical routing arrangement and respective terminals at the node so as to provide the local access to the network through the node. The method may involve sending an outbound local signal to a given terminal (220, 222 . . . ); at the given terminal, forwarding to the all-optical routing arrangement (20x) on an intra-node optical pathway, an optical signal that is derived from the outbound local signal; and in the all-optical routing arrangement (20x), routing the derived optical signal from the intra-node optical pathway to any one of the n t inter-node optical pathways.

The value of t may be greater than or equal to 2 and, if there are f<t failures in f terminals or respective intra-node optical pathways between the f terminals and the all optical routing arrangement, then the sending step may include sending the outbound local signal to one of t−f non failing terminals; and the forwarding step may include forwarding the derived optical signal from one of the t−f non failing terminals to the all-optical routing arrangement.

The method may further involve receiving an incoming optical signal on one of the inter-node optical pathways; in the all-optical routing arrangement, routing the incoming optical signal to any one of the t intra-node optical pathways to arrive at a receiving terminal; and at the receiving terminal, providing an inbound local signal that is derived from the routed incoming optical signal.

The value of t may be greater than or equal to 2 and, if there are f<t failures in f terminals or respective intra-node optical pathways between the f terminals and the all optical routing arrangement, then the routing step may include routing the incoming optical signal to one of the t−f non failing terminals; and the providing step may include one of the t−f non failing terminals providing the inbound local signal.

Many alternatives, modifications, and variations will be apparent to those skilled in the art in light of the above teachings. For example, the number and relative location and interconnection of elements may be varied while remaining within the scope of the present invention. Likewise, the steps involved in methods described herein may be implemented in a manner different than as described above. It is therefore to be understood that within the scope of the appended claims and their equivalents, the invention may be practiced otherwise than as specifically described herein.

What is claimed is:

1. An arrangement at a node of an optical communication network, the arrangement comprising:
a) t terminals configured to provide local access to the network through the node, wherein t≧1;
b) an all-optical routing arrangement configured to route optical signals among n optical pathways extending from the node, wherein n>t; and
c) the n optical pathways configured to carry optical signals, wherein the n optical pathways include:
c1) n−t inter-node optical pathways configured to carry optical signals into and out of the node to respective other elements in the optical communication network; and −c2) t intra-node optical pathways dedicated to carry optical signals between the routing arrangement and respective terminals so as to provide the local access to the network through the node.

2. The arrangement of claim 1, wherein:
t=1.

3. The arrangement of claim 1, wherein:
t≧2; and
if there are f failures in f terminals or respective intra-node optical pathways between the f terminals and the all-optical routing arrangement, wherein f<t, then t−f non-failing terminals are configured to continue to provide the local access to the network through the node so as to prevent node isolation.

4. The arrangement of claim 3, wherein:
t is a smallest integer ≧n^{1/2}.

5. A method of performing optical mesh restoration in a network including the arrangement of claim 3, the method comprising:
establishing communication between the node and the first and second other network elements;
determining a failure in one of the first terminal and the second terminal; and
performing optical mesh restoration so as to continue the routing of optical signals among the first and second optical pathways notwithstanding the failure in one of the first terminal and the second terminal.

6. The arrangement of claim 1, wherein:
at least one of the terminals is configured to communicate with a device providing network layer control to the first terminal.

7. The arrangement of claim 1, wherein:
at least one of the terminals is configured to communicate with a centralized network control entity.

8. An arrangement at a node of an optical communication network, the arrangement comprising:
a first optical pathway extending from the node toward a first other element in the optical communication network, and configured to carry optical signals into and out of the node;
a second optical pathway extending from the node toward a second other element in the optical communication network, and configured to carry optical signals into and out of the node;
a third optical pathway, extending from the node and configured to carry optical signals;
an all-optical routing arrangement configured to route optical signals from any of the first, second and third optical pathways to any other optical pathway selected from among the first, second and third optical pathways; and
at least a first terminal connected to the routing arrangement only via the third optical pathway.

9. The arrangement of claim 8, wherein:
the first terminal is configured to communicate with a device providing network layer control to the first terminal.

10. The arrangement of claim 8, wherein:
the first terminal is configured to communicate with a centralized network control entity.

11. The arrangement of claim 8, further comprising:
a fourth optical pathway, extending from the node and configured to carry optical signals; and
a second terminal connected to the routing arrangement only via the fourth optical pathway.

12. The arrangement of claim 11, wherein:
the second terminal is configured to communicate with a device providing network layer control to the second terminal.

13. The arrangement of claim 11, wherein:
the second terminal is configured to communicate with a centralized network control entity.

14. The arrangement of claim 11, wherein:
a failure of the first terminal does not interrupt the carrying of optical signals between the second terminal and the all-optical routing arrangement; and
a failure of the second terminal does not interrupt the carrying of optical signals between the first terminal and the all-optical routing arrangement.

15. The arrangement of claim 8, wherein:
a failure of the first terminal does not interrupt the routing of optical signals between the first and second optical pathways.

16. A method of locally accessing an optical communication network through a node having t≧1 terminals and n>t optical pathways extending from the node, the n optical pathways including (a) n−t inter-node optical pathways configured to carry optical signals into and out of the node to respective other elements in the optical communication network, and (b) t intra-node optical pathways dedicated to carry optical signals between an all-optical routing arrangement and respective terminals at the node so as to provide the local access to the network through the node, the method comprising:
sending an outbound local signal to a given terminal;
at the given terminal, forwarding to the all-optical routing arrangement on an intra-node optical pathway, an optical signal that is derived from the outbound local signal; and
in the all-optical routing arrangement, routing the derived optical signal from the intra-node optical pathway to any one of the n−t inter-node optical pathways.

17. The method of claim 16, wherein t≧2 and, if there are f<t failures in f terminals or respective intra-node optical pathways between the f terminals and the all-optical routing arrangement, then:
the sending step includes sending the outbound local signal to one of t−f non-failing terminals; and
the forwarding step includes forwarding the derived optical signal from one of the t−f non-failing terminals to the all-optical routing arrangement.

18. The method of claim 16, further comprising:
receiving an incoming optical signal on one of the inter-node optical pathways;
in the all-optical routing arrangement, routing the incoming optical signal to any one of the t intra-node optical pathways to arrive at a receiving terminal; and
at the receiving terminal, providing an inbound local signal that is derived from the routed incoming optical signal.

19. The method of claim 18, wherein t≧2 and, if there are f<t failures in f terminals or respective intra-node optical pathways between the f terminals and the all-optical routing arrangement, then:
the routing step includes routing the incoming optical signal to one of the t−f non-failing terminals; and
the providing step includes one of the t−f non-failing terminals providing the inbound local signal.
